(19) United States
(12) Patent Application Publication
(10) Pub. No.: US 2021/0075203 A1
(43) Pub. Date: Mar. 11, 2021

(54) Outlet Box

(71) Applicant: Monty D. McDonald, San Antonio, TX (US)

(72) Inventor: Monty D. McDonald, San Antonio, TX (US)

(21) Appl. No.: 16/841,781

(22) Filed: Apr. 7, 2020

Related U.S. Application Data
(60) Provisional application No. 62/922,996, filed on Sep. 11, 2019.

(51) Int. Cl. H02G 3/12; H02G 3/08

(52) U.S. Cl. CPC H02G 3/121; H02G 3/081

(57) ABSTRACT

An outlet box with flexible side surfaces that allow the side surfaces to compress inwards as the outlet box is inserted into a hole in a wall then decompress to original position once the outlet box is inserted into a wall. Elongated slits in the side surfaces create the necessary flexibility. Exterior wedge shaped flanges on the side surfaces cause the side surfaces to gradually compress as the outlet box is inserted into a wall as the interior of the wall applies pressure on the flanges.

### CROSS-REFERENCES TO RELATED APPLICATIONS

This application claims priority to U.S. provisional application No. 62/922,996.

### STATEMENT REGARDING FEDERALLY SPONSORED RESEARCH OR DEVELOPMENT

Not applicable.

### BACKGROUND OF THE INVENTION

### 1. Field of the Invention

The present invention relates to an electric outlet box for housing electrical components in a wall or other structure.

### 2. Description of the Related Art.

Outlet boxes, also referred to as switch boxes, are well known in the art. Generally, outlet boxes are installed during construction of a building or structure to house electrical outlets, switches, or other electrical components. Outlet boxes generally comprise a hollow rectangular prism without a front surface (a box). Generally, outlet boxes are installed by cutting a hole in the drywall. Electrical wiring is pulled through the hole in the drywall and inserted through an opening in the rear surface of the outlet box. The outlet box is then inserted into the hole in the dry wall.

Prior art outlet boxes are secured to the drywall by screw operated wings. At least one wing/screw assembly is attached to a corner of the outlet box proximate the outer surface of the outlet box. The installer rotates the screw using a screw driver, which causes the wing to rotate away from the outlet box. The wings are rotated until the wing contacts the wall, which secures the outlet box in place.

### BRIEF SUMMARY OF THE INVENTION

The present invention is an improved outlet box comprising slits in the side surfaces of the box that allow the side surfaces of the box to compress as the outlet box is inserted through the hole and into the wall then decompress back to their original position once the outlet box is inserted into the wall. The improved outlet box design eliminates the need to include a screw/wing assembly, which reduces manufacturing costs and improves efficiency of installation.

The improved outlet box uses the general size, shape, and construction material of a prior art outlet box. Instead of rigid side surfaces, the side surfaces have horizontal slits extending from the front opening of the box almost the entire width of the side surface. The slits allow the side surfaces to the outlet box to flex inward and outward.

Wedge shaped flanges are integral, or otherwise attached, to the side surfaces. The thin edge of the wedge is oriented towards the rear of the outlet box. The thick end of the wedge is oriented towards the opening of the outlet box.

To install the improved outlet box, the installer pushes inward on the side surfaces. The slits allow the side surfaces to compress inward. When the outlet box is partially inserted into the pre-cut hole in the wall, the wall edges forming the pre-cut hole apply inward pressure on the side flanges, keeping the side surfaces compressed inward. When the side surfaces are compressed inward far enough that the distance between the opposing side flanges is less than the length of the hole in the wall, the outlet box can be fully inserted through the pre-cut hole.

Once the outlet box is inserted far enough into the hole that the wall is no longer applying pressure on the outer surface of the side flange, the tension in the compressed side surfaces causes the side surfaces to decompress back to their original position.

The side flanges and the tension from the side surfaces secures the outlet box in place.

### BRIEF DESCRIPTION OF THE SEVERAL VIEWS OF THE DRAWINGS

FIG. 1 is a perspective view of a first embodiment of the improved outlet box.

FIG. 2 is a front view of the first embodiment of the improved outlet box.

FIG. 3 is a side view of the first embodiment of the improved outlet box. The right and left side views are identical.

FIG. 4 is a top view of the first embodiment of the improved outlet box. The top and bottom views are identical.

FIG. 5 is a side view of the first embodiment of the improved outlet box inserted through a hole in a wall.

FIG. 6 is a front perspective view of the first embodiment of the improved outlet box with the side surfaces compressed.

### DETAILED DESCRIPTION OF THE INVENTION

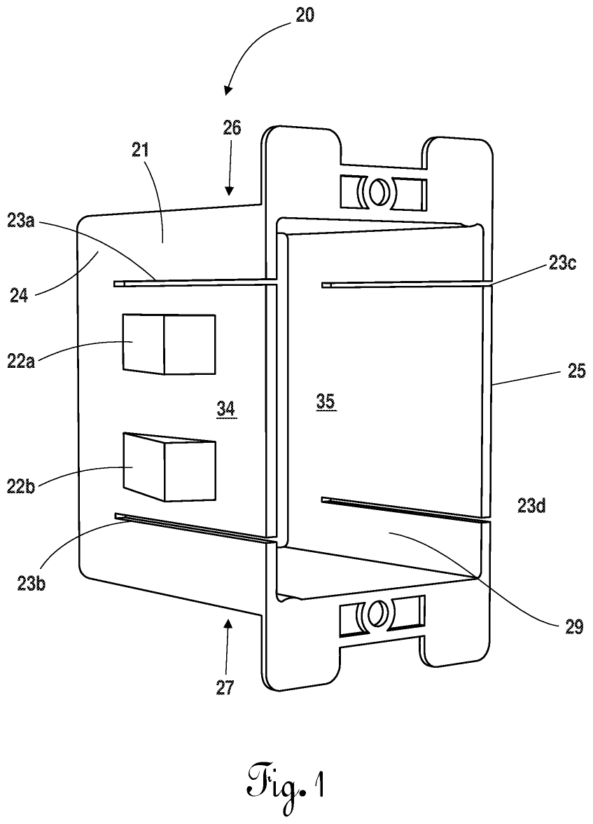

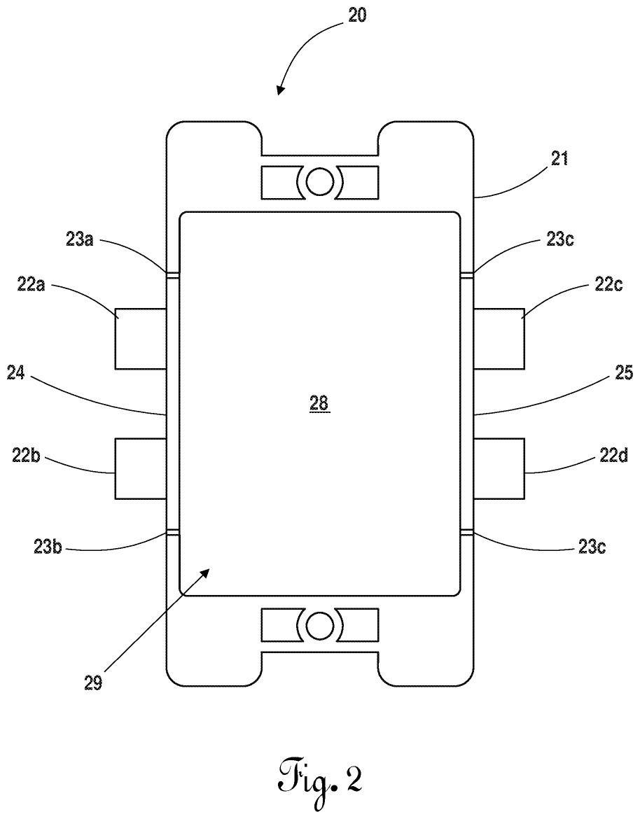

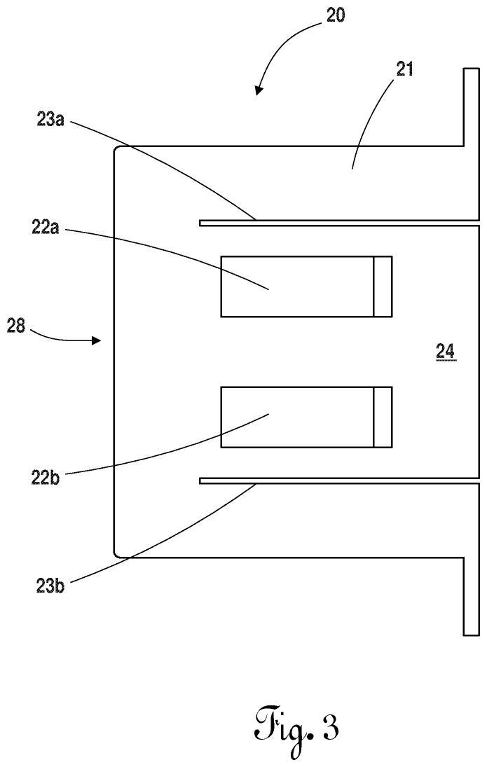

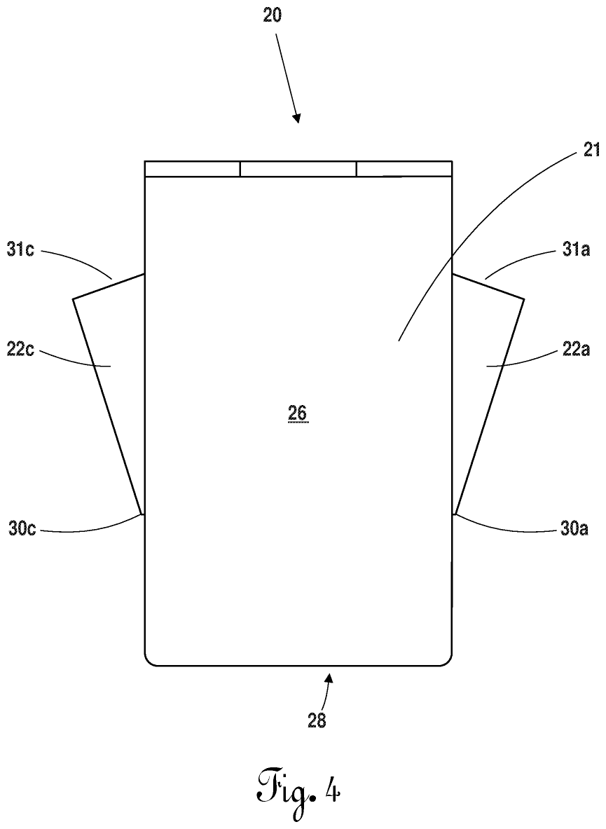

The structure of a first embodiment of the improved outlet box is described with reference to FIGS. 1-4.

The outlet box 20 comprises a housing 21, four side flanges 22, and four slits 23.

The housing 21 further comprises a first side surface 24, second side surface 25, a top surface 26, a bottom surface 27, and a rear surface 28. The side surfaces 24, 25, top surface 26, bottom surface 27, and rear surface 28 form a box with a front opening 29.

Two slits 23a, 23b are cut into first side surface 24. Slits 23a, 23b are rectangular prism shaped. Slits 23a, 23b are cut into the edge of side surface 24 adjacent the opening 29. Slits 23a, 23b are equal in width to the width of side surface 24. Slits 23a, 23b are approximately 0.1 millimeter in height. Slits 23a, 23b are approximately 71.43% the length of the side surface 24.

Slits 23a, 23b are parallel to top surface 26 and bottom surface 27, and perpendicular opening 29. Slit 23a is proximate the intersection of side surface 24 and top surface 26. Slit 23b is proximate the intersection of side surface 24 and bottom surface 27.

Slits 23a and 23b form a first side surface tab 34 on first side surface 24 between the two slits 23a, 23b.

Two slits 23c, 23d are cut into second side surface 25. Slits 23c, 23d are rectangular prism shaped. Slits 23c, 23d are cut into the edge of side surface 25 adjacent the opening 29. Slits 23c, 23d are equal in width to the width of side surface 25. Slits 23c, 23d are approximately 0.1 millimeter in height. Slits 23c, 23d are approximately 71.43% the length of the side surface 25.

Slits 23c, 23d are parallel to top surface 26 and bottom surface 27 and perpendicular opening 29. Slit 23c is proximate the intersection of side surface 25 and top surface 26. Slit 23d is proximate the intersection of side surface 25 and bottom surface 27.

Slits 23c and 23d form a second side surface tab 35 on the second side surface 25 between the two slits 23c, 23d.

Slit 23c is coplanar slit 23a on opposing sides of the outlet box 20. Slit 23d is coplanar slit 23b on opposing sides of the outlet box 20.

Side flanges 22a, 22b are integral or otherwise attached to the exterior of first side surface 24. Side flanges 22a, 22b are wedge prism shape. Side flanges 22a, 22b have a thin end 30a, 30b, and a thick end 31a, 31b. The thin end 30a, 30b is oriented closer to the rear surface 28. The thick end 31a, 31b is oriented closer to the opening 29. The inner surfaces of side flanges 22a, 22b are parallel slits 23a, 23b, top surface 26, and bottom surface 27, and perpendicular opening 29 and rear surface 28. Side flanges 22a, 22b are located on first side surface 24 beneath slit 23a and above slit 23b. The distance between the opening 29 and thick end 31a, 31b of side flanges 22a, 22b is greater than the thickness of the wall 32 wherein the outlet box 20 is to be installed. Ideally, the distance between the opening 29 and thick end 31a, 31b is only slightly larger than the thickness of the wall 32.

Side flanges 22c, 22d are integral or otherwise attached to the exterior of second side surface 25. Side flanges 22c, 22d are wedge prism shape. Side flanges 22c, 22d have a thin end 30c, 30d, and a thick end 31c, 31d. The thin end 30c, 30d is oriented closer to the rear surface 28. The thick end 31c, 31d is oriented closer to the opening 29. The inner surfaces of side flanges 22c, 22c are parallel slits 23c, 23d, top surface 26, and bottom surface 27, and perpendicular opening 29 and rear surface 28. Side flanges 22c, 22d are located on second side surface 25 beneath slit 23c and above slit 23d. The distance between the opening 29 and thick end 31c, 31d of side flanges 22c, 22d is greater than the thickness of the wall 32 wherein the outlet box 20 is to be installed. Ideally, the distance between the opening 29 and thick end 31c, 31d is only slightly larger than the thickness of the wall 32.

Flange 22c is coplanar Flange 22a on opposing sides of the outlet box 20. Flange 22d is coplanar Flange 22b on opposing sides of the outlet box 20.

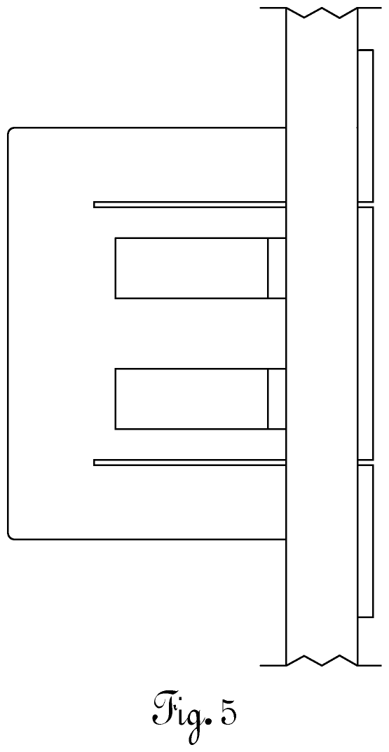

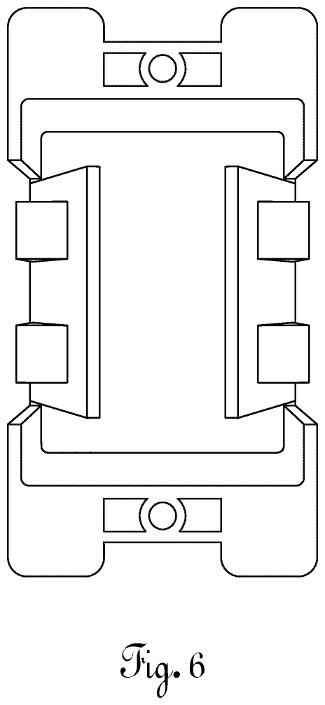

The function of the outlet box 20 is explained with reference to FIGS. 5-6. A hole 33 is cut into a wall 32. The hole 33 can be pre-cut into the wall 32 during an earlier stage of construction or cut as part of the installation process.

The rear surface 28 of the outlet box is aligned with the hole 33. The hole 33 should be slightly larger than the rear surface 28. The rear wall 28 is inserted through the hole 33 until the thin ends 30 of the flanges 22 contacts the exterior of the wall 32 temporarily precluding the outlet box 20 from being inserted further into the hole 33.

The installer applies inward pressure on side surface tabs 34, 35. The installer can apply inward pressure on side surface tabs 34, 35 by directly applying inward pressure to side surface tabs 34, 35. The installer can indirectly apply inward pressure on side surface tabs 34, 35 by pushing the outlet box 20 further into the hole 33 which causes the interior of hole 33 to apply pressure on side flanges 22. The wedge shape of the flanges 22 makes the inward pressure from the interior of the hole 33 increase gradually, which makes it easier for the installer to insert the outlet box 20 into the hole 33. The pressure from the interior of the hole 33 on the flanges 22 applies inward pressure on the side surface tabs 34, 35.

Inward pressure on the side surface tabs 34, 35 causes the side surface tabs 34, 35 to compress inwards. As the side surface tabs 34, 35 compress inwards, the outer surface of the flanges 22 also compresses inwards and incrementally more of the outlet box can be inserted through the hole 33.

The installer continues inserting the outlet box 20 until the entirety of the flanges 22 are inside the wall 33. Once the thick ends 31 of the flanges 22 are pushed past the wall 32, the interior of hole 33 no longer applies inward pressure on side surface tabs 34, 35. The tension in side surface tabs 34, 35 automatically causes the side surface tabs 34, 35 to decompress back to their original position. Once side surface tabs 34, 35 are decompressed back to their original position, the distance between the opposing thick ends 31 of opposing side flanges 22 is greater than the length of the hole 33.

The friction fit between the side surface 24, 25, top surface 26, bottom surface 27 and the interior of hole 33 secure the outlet box to the wall 32. The thick ends 31 of the flanges 22 further secure the outlet box to the wall by preventing the outlet box 20 from sliding out of the hole 33.

The outlet box 20 normally does not need to be removed from hole 33 because installation is permanent. In the event outlet box 20 needs to be removed, inward pressure is applied to side surface tabs 34, 35 so that the tabs 34, 35 and flanges 22 compress inwards. Once the distance between opposing thick ends 31 of opposing flanges 22 is less than the length of hole 33, the outlet box can be pulled back through the hole 33 and removed.

1. An outlet box comprising:
a housing having a top surface, a first side surface, a second side surface, a bottom surface;
wherein said first side surface has an elongated slit and a wedge shaped flange.

2. The outlet box of claim 1 wherein:
the second surface has an elongated slit and a wedge shaped flange.

3. An outlet box comprising:
a housing having a top surface, a first side surface, a second side surface, a bottom surface;
wherein said first side surface has first and second elongated slits and fist and second exterior wedge shaped flanges;
wherein said second side surface has third and fourth elongated slits and third and fourth exterior wedge shaped flanges.

4. The outlet box of claim 3 wherein:
the first slit is proximate the intersection of the first side surface and the top surface and the second slit is proximate the intersection of the bottom surface and the first side surface;
wherein the third slit is proximate the intersection of the second side surface and the top surface, and the fourth slit is proximate the intersection of the bottom surface and the second side surface.

5. The outlet box of claim 3 wherein:
the first and second flanges are between the first and second slits on the first side surface, and the third and fourth flanges are between the third and fourth slits on the second side surface.

6. A method of installing an outlet box having a top surface, a bottom surface, a first side surface, a second side surface, a rear surface and an opening wherein said first side surface has first and second elongated slits and first and second exterior wedge shaped flanges and said second side surface has third and fourth elongated slits and third and fourth exterior wedge shaped flanges comprising the following steps:
inserting the rear surface of the outlet box into precut hole in a wall;
applying forward pressure on the outlet box so that the interior of the hole applies inward pressure on the four side flanges;
compressing the first and second surfaces inward until the distance between the opposing flanges is less than the length of the hole;
inserting the outlet box through the hole so that the entire flange is inside the wall;
decompressing the first and second side surfaces using the natural tension of the side surfaces.
